(19) United States
(12) Patent Application Publication
(10) Pub. No.: US 2025/0334239 A1
(43) Pub. Date: Oct. 30, 2025

(54) Light Provider

(71) Applicant: Ishmael Hassan Kamara, Lanham, MD (US)

(72) Inventor: Ishmael Hassan Kamara, Lanham, MD (US)

(21) Appl. No.: 19/188,023

(22) Filed: Apr. 24, 2025

Related U.S. Application Data
(60) Provisional application No. 63/638,364, filed on Apr. 24, 2024.

(51) Int. Cl. F21S 9/03; F21V 23/04

(52) U.S. Cl. CPC F21S 9/037; F21V 23/0442

(57) ABSTRACT

The disclosure pertains to a solar-powered lighting device designed for flexibility and efficiency in providing illumination and power. The lighting device features a light source powered by a solar panel, which converts solar energy into electrical energy stored in a removable and rechargeable battery. The lighting device can be attached to various mounts by an adaptable attachment means. The lighting device may additionally serve as a power bank that enables the charging of external electronic devices via a built-in USB port or similar connection means.

### CROSS REFERENCE TO RELATED APPLICATION

This application is a non-provisional application that claims priority to U.S. Provisional Patent Application No. 63/638,364, filed on Apr. 24, 2024, and entitled LIGHT PROVIDER, the content of which is incorporated herein by reference in its entirety.

### FIELD

The present disclosure relates generally to the field of renewable energy devices and, more specifically, to solar-powered lighting systems. More specifically, the present disclosure pertains to a device designed to provide light and energy through solar energy harvesting. The field of the disclosure encompasses aspects of energy conversion, storage technologies, and portable lighting solutions, highlighting advancements in sustainable and renewable energy utilization for everyday applications.

### BACKGROUND

In recent years, the demand for portable, versatile, and environmentally friendly lighting solutions has significantly increased due to the growing awareness of renewable energy sources and the need for energy efficiency in various applications, from outdoor recreational activities to emergency preparedness and home use. Traditional lighting solutions often rely on non-renewable energy sources, lack flexibility in terms of placement and power source, and offer limited functionality beyond illumination.

Solar-powered lighting devices have emerged as a sustainable alternative, harnessing the sun's energy to provide illumination. However, existing solar-powered lights often suffer from several drawbacks, including fixed installation locations, non-removable batteries that limit the lifespan of the device, and the inability to serve additional functions beyond lighting. Moreover, existing solutions are not as user-friendly and are not equipped with the same security features.

### SUMMARY

In light of the foregoing background, the following presents a simplified summary of the present disclosure to provide a basic understanding of some aspects of the disclosure. This summary is not an extensive overview of the disclosure. It is not intended to identify key or critical elements of the disclosure, or to delineate the scope of the disclosure. The following summary merely presents some concepts of the disclosure in a simplified form as a prelude to the more detailed description provided below.

The present disclosure describes a multifaceted solar-powered lighting device intended to deliver a steady and efficient source of light and power, particularly benefiting individuals without access to electricity. The lighting device boasts a wireless light source encased within a versatile housing that affords nearly universal compatibility with various mounting systems, including a solar ring and a mount. The adaptability, user-friendly design, and provision of effective illumination of the disclosed lighting device represent a significant advancement over existing solar-powered lights.

One aspect of the disclosure is the solar charging device that serves dual functions: illuminating outdoor spaces effectively while concurrently harvesting solar energy. The device comprises a solar ring featuring side lighting for extended illumination, a highly efficient solar panel for energy conversion, and a motion sensor for energy-saving light activation. The solar ring facilitates outdoor operation of the lighting device by collecting solar energy.

Further disclosed is the solar panel's strategic top-surface placement for optimal energy harvesting, converting sunlight into electrical energy stored in an internal battery. The side lights, capable of independent or simultaneous operation with the main light, extend the illumination range and can indicate battery level. The motion sensor adds a security dimension by lighting upon detection of movement, switching off after inactivity to conserve energy and extend device life.

The device also features a locking mechanism enhancing its security and stability. The lock and key system, incorporating shape-specific connections, prevents rotational movement, ensuring a stable attachment between the solar ring, case, and mount.

The case of the device acts as a protective shell for the wireless light and battery, made from durable, weather-resistant materials suitable for outdoor installation. The case integrates a cover, an opening mechanism for easy access to the light and battery, and a tightening mechanism for secure mount attachment.

The wireless lighting device and battery, secured in the case by a magnet-assisted molding feature, provides energy storage and the potential to power other devices via USB or a similar interface. The mount, equipped with holes for wall attachment and a locking and threading system, allows for secure, easy, and rotatable connections with the device's components.

In summary, this solar-powered lighting device encapsulates an ingenious blend of energy efficiency, convenience, and security, embodying a robust, adaptable, and user-friendly solution for lighting needs in electricity-scarce areas.

Aspects of the disclosure pertain to a solar-powered lighting device designed for flexibility and efficiency in providing illumination and power. The lighting device features a light source powered by a solar panel, which converts solar energy into electrical energy stored in a removable and rechargeable battery. The device can be attached to various mounts by adaptable attachment means, enhancing its utility across different environments. The device has dual functionality: serving as a portable light source, and also as a power bank, allowing for the charging of external electronic devices via a built-in USB port or similar connection means. This multifunctional device is tailored for users seeking sustainable, reliable, and versatile lighting solutions for outdoor, emergency, or everyday use, emphasizing eco-friendly energy consumption and user convenience.

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1 is a front view of a solar charging hub depicting a case connected to a solar ring, according to certain aspects of the present disclosure.

FIG. 2 is a side view of a solar charging hub, according to certain aspects of the present disclosure.

FIG. 3 is a back view of a solar charging hub, according to certain aspects of the present disclosure.

FIG. 4 is a front-facing view of a case for a light source, according to certain aspects of the present disclosure.

FIG. 5 is a back view of a case while attached to a mount for a light source, according to certain aspects of the present disclosure.

FIG. 6 is a side view of a case for a light source, according to certain aspects of the present disclosure.

FIG. 7 is a back view of a case for a light source while not attached to a mount, according to certain aspects of the present disclosure.

FIG. 8 is side view of a back of a case for a light source while not attached to a mount, according to certain aspects of the present disclosure.

FIG. 9 is a front view of a solar ring without a case attached, according to certain aspects of the present disclosure.

FIG. 10 is a side view of a solar ring without a case attached, according to certain aspects of the present disclosure.

FIG. 11 is aback view of a solar ring without a case attached, according to certain aspects of the present disclosure.

FIG. 12 is a prospective view of a mount, according to certain aspects of the present disclosure.

FIG. 13 is a front view of a mount, according to certain aspects of the present disclosure.

FIG. 14 is a side view of a mount, according to certain aspects of the present disclosure.

FIG. 15 is a front view of the inside of a case while open and with a light source inside, according to certain aspects of the present disclosure.

FIG. 16 is a side view of the inside of a case while open and with a light source inside, according to certain aspects of the present disclosure.

FIG. 17 is a prospective view of the inside of a case while open and with the light source removed, according to certain aspects of the present disclosure.

FIG. 18 is a back view of a light source, according to certain aspects of the present disclosure.

FIG. 19 is a front view of a light source, according to certain aspects of the present disclosure.

FIGS. 20-56 illustrate various views of a wireless LED light system, according to certain aspects of the present disclosure.

FIGS. 57-64 illustrate various views, components, and a method of assembly of a wireless LED light system, according to certain aspects of the present disclosure.

### DETAILED DESCRIPTION

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings.

The present disclosure as well as various commercial and consumer products may provide a solar-powered lighting device, designed to provide an efficient and consistent source of light and energy to people without electricity. In one construction, the solar-powered lighting device comprises a wireless light source that attaches securely to a case, which features a mounting system thereby allowing for near universal compatibility with potential mounts including primary mounts, such as a solar ring and a mount.

This innovative approach ensures that the solar-powered lighting device 100 not only provides light while collecting energy but also accommodates mounting for variable positioning. The inclusion of the lock 144 and the ergonomic design of the opening mechanism 177 make the solar-powered lighting device 100 versatile and suitable for outside storage without concern of theft. Through its unique combination of adaptability, user-friendliness, and effective lighting, the solar-powered lighting device offers a significant improvement over any existing solar-powered light.

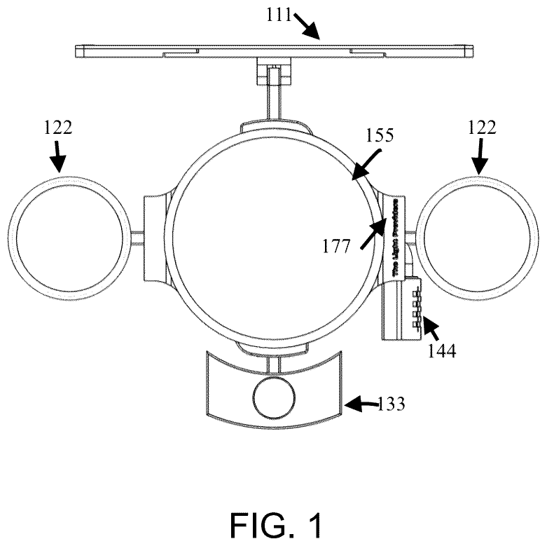

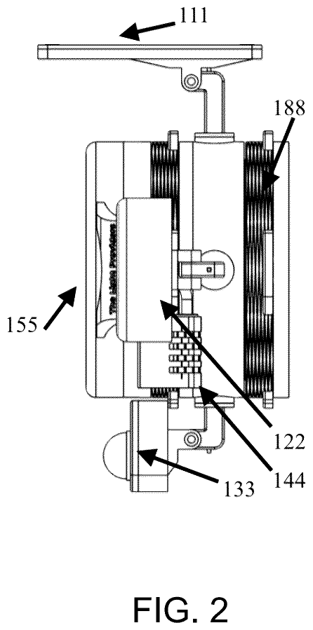

In one construction shown in FIGS. 1, 2, and 3 the solar-powered lighting device 100 operates as an outdoor lighting source while collecting solar energy. In this construction, the wireless light source 500 is inside of the case 400, which is attached to the solar ring 200. The solar ring 200 includes side lighting 122 that provides additional lighting, a solar panel 111 that converts solar energy into electrical energy, and a motion sensor 133, which is designed to activate the light source when motion is detected and conserve the energy of the light source when necessary. Through this connection, the solar ring collects solar energy while enabling the lighting device to operate outdoors.

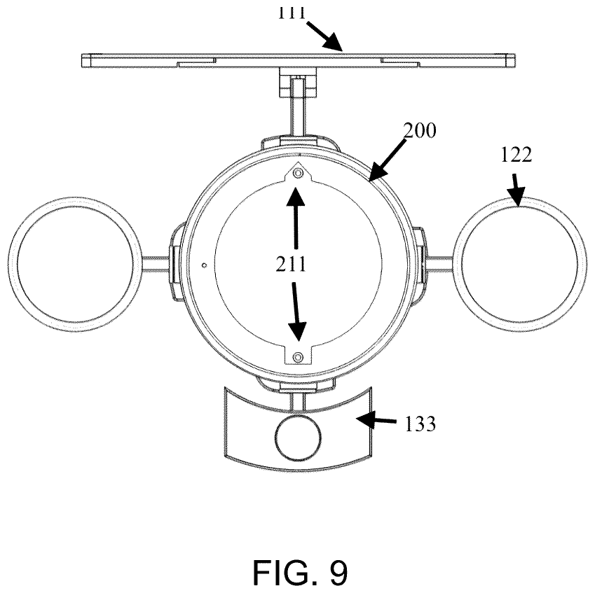

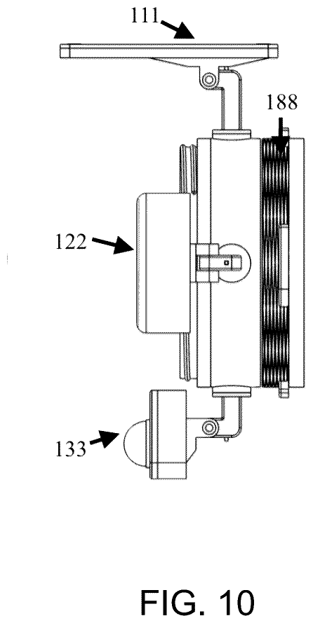

As shown in FIGS. 1-3 and 9-11, the solar ring 200 of the solar-powered lighting device 100 includes a solar panel 111 that is strategically positioned on the top surface of the device. The solar panel is responsible for harvesting solar energy during daylight hours. This energy is then converted into electrical energy, which is stored in an internal battery system. The solar panel is designed to be highly efficient and capable of operating under various light conditions to ensure maximum energy accumulation.

As shown in FIGS. 1-3 and 9-11, the solar ring 200 of the solar-powered lighting device 100 includes two side lights integrated into the sides of the device, providing additional lighting capabilities separate from the central light. These side lights are designed to illuminate a broader area and can be activated independently or in conjunction with the main light, depending on the user's requirements. The side lights may also be used to indicate the battery power of the internal battery.

As shown in FIGS. 1-3 and 9-11 the solar ring 200 of the solar-powered lighting device 100 may include a motion sensor that detects movement within a predefined range. Upon detection of motion, the sensor automatically activates the central solar-powered light 500. This not only provides necessary illumination but also enhances security by deterring potential intruders. When no motion is detected for a set period, the lights are turned off to conserve stored energy, thereby increasing efficiency and prolonging the operational lifespan of the device.

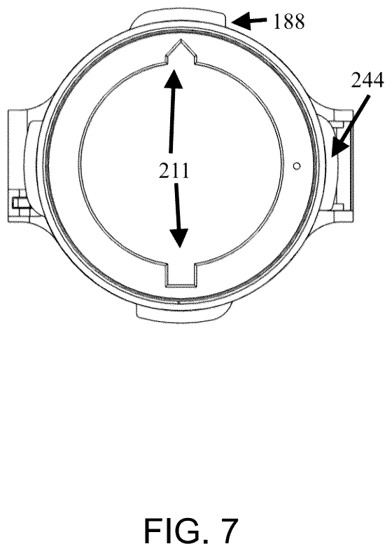

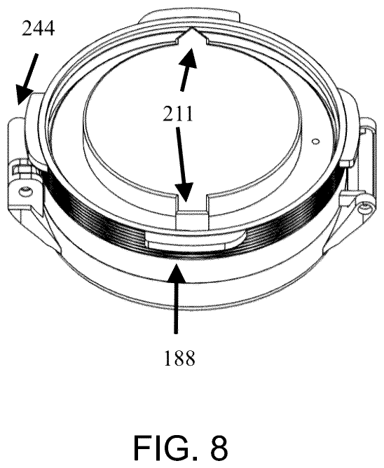

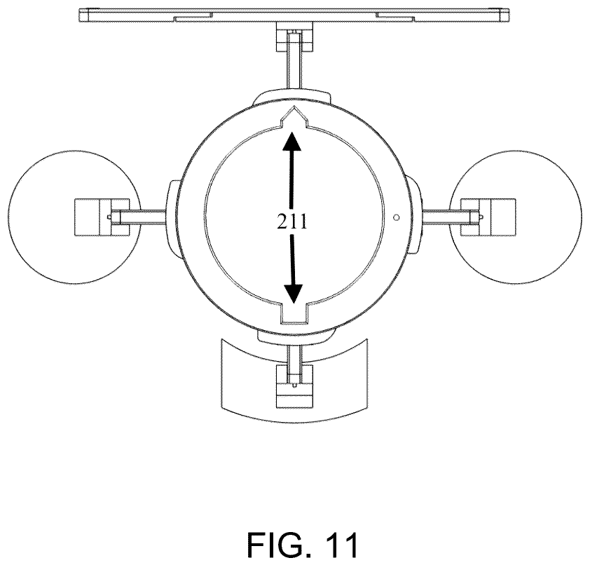

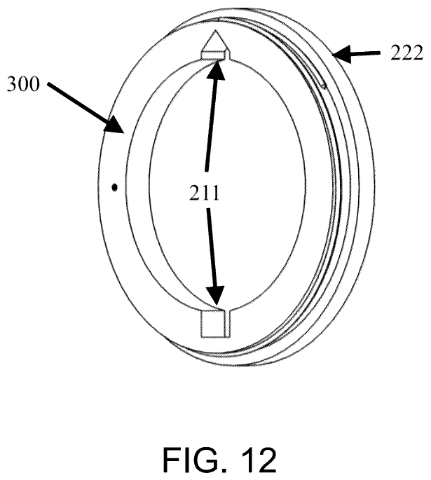

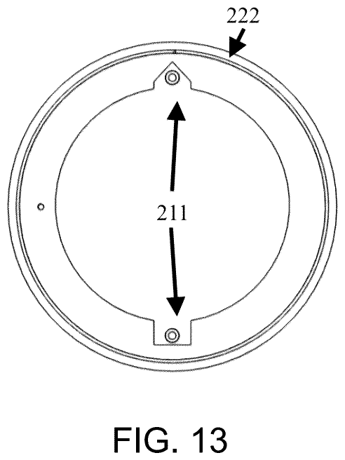

Referring to FIG. 11, the back of the solar ring 200 also contains a lock and key mechanism 211, which attaches the solar ring 200 to the case 400 and to the mount 300. The key and lock mechanism enhances the stability of the connection by stopping rotation via a square and triangular shape connection with the other end of the mechanism. FIGS. 7-9 and 12-13 also depict the lock and key mechanism in the mount 300, case 400 and the solar ring. 200 The key and lock mechanism allow each part to attach to the corresponding part in a stable manner.

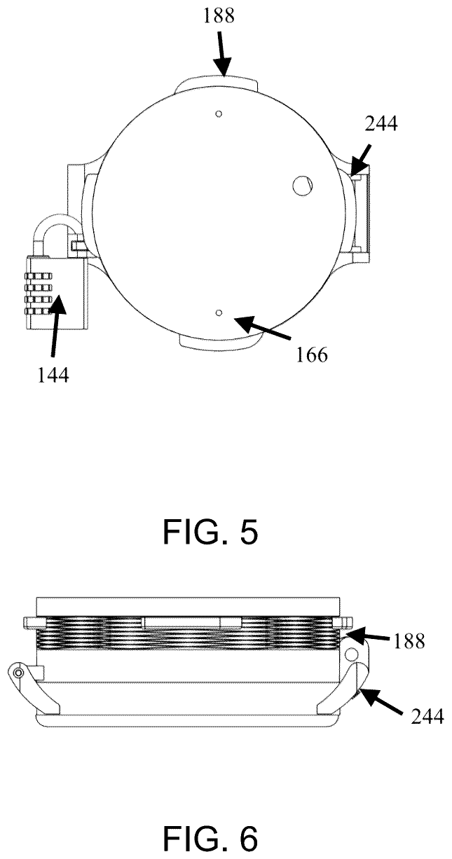

FIGS. 1-5 display the lock mechanism 144 integrated into the case 400. The lock mechanism 144 enhances the security of the device, preventing unauthorized access or tampering with the internal components. The lock can be a mechanical or electronic locking system, depending on the security requirements. A simple iteration would be a pad lack.

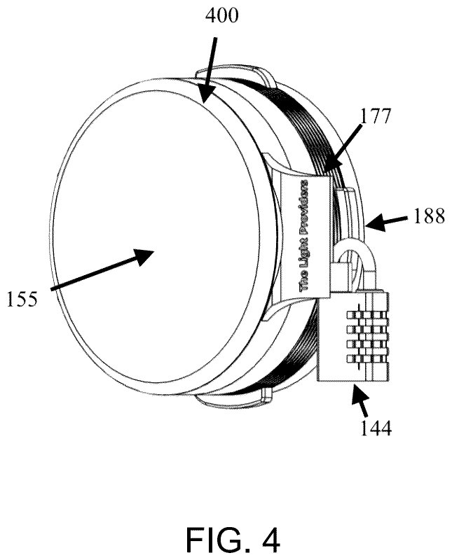

Referring to FIGS. 4-8, the present disclosure provides for a case 400 that is a protective and unifying enclosure for the 500 wireless lighting and battery source. The case 400 is constructed from durable, weather-resistant materials suitable for outdoor use. The case is designed to be tamper-proof and secure, with a streamlined aesthetic that allows for easy installation on various surfaces. As depicted in FIG. 4, the case 400 features a cover 155, an opening mechanism 177, a tightening mechanism 188 and a locking mechanism 144. The opening mechanism 177, is on the side of the case, opposite the hinge 244 and allows the user to open the case to access the wireless light source and battery 500. The opening mechanism 177 is designed for ease of use with sufficient area to grip and pull to open the secure case.

Further, the case 400 includes a tightening mechanism 188, which allows the user to easily fasten and loosen the attachment between the case and the various mounting options. The tightening mechanism features grooved ridges with four protruding portions for the user to grip. The grooved ridges tighten and secure the mechanism, attaching the case to the various mounts, and loose to remove the case from the various mounts. The user simply grips the protruding portions and twists to fasten and loosen the tightening mechanism.

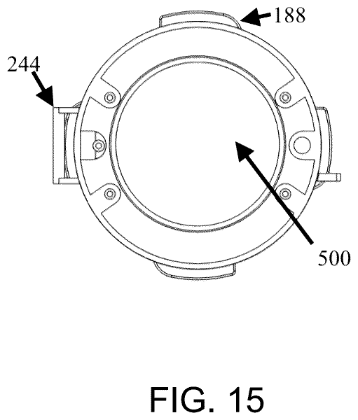

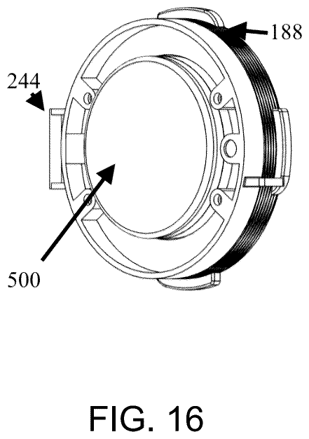

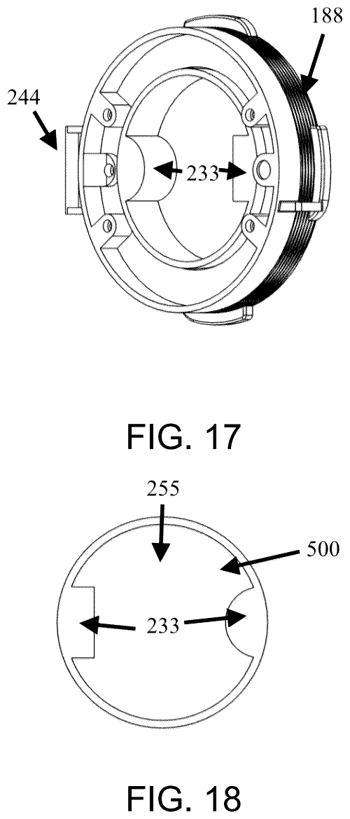

As depicted in FIGS. 15-17, the case 400 can be opened to reveal the wireless lighting device and battery 500. The lighting device and battery 500 are secured inside of the case by a molding feature 233 of the case that uses magnets to secure the lighting device and battery to the inside of the case. The molding feature 233 inside of the case 400 has a circle and a square portion that will correspond to the back of the wireless lighting device and battery 500.

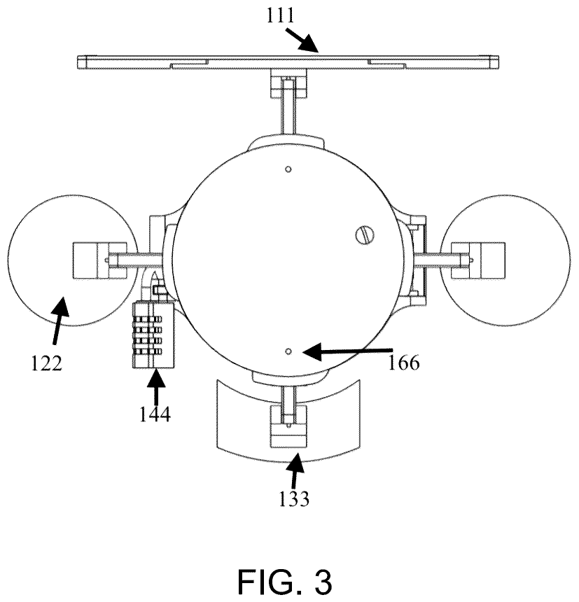

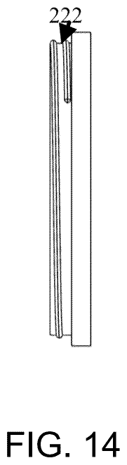

Referring to FIGS. 3, 5 and 12-15, the mount 300 has holes 166, which allow for the mounts to be screwed into and secured to a wall. Referring to FIGS. 12-14, the mount 300 also features a lock and key mechanism 211 and threading 222, which allow the mount to be securely attached to various parts including the case 400 and the solar ring 200. The lock and key mechanism 211 serve to enhance the stability of the connection by stopping rotation via a square and triangular shape connection with the other end of the mechanism. The threading 222 allows for versatile mounting by using male and female threading to make a secure and universal attachment to various mounts and components featuring threading. The threading 222, along with the tightening mechanism 188, allows the user ease in connecting and disconnecting the various parts of the device by twisting the mechanism.

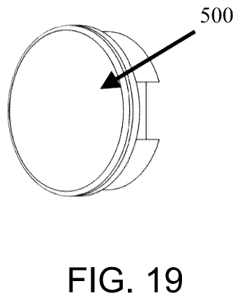

Referring to FIGS. 18-19, the wireless lighting device and battery 500 features a molded back 233 for secure attachment to the case and an interior battery 255 that serves both to retain the solar energy and to provide energy to other devices through connection with a USB port or similar mechanism.

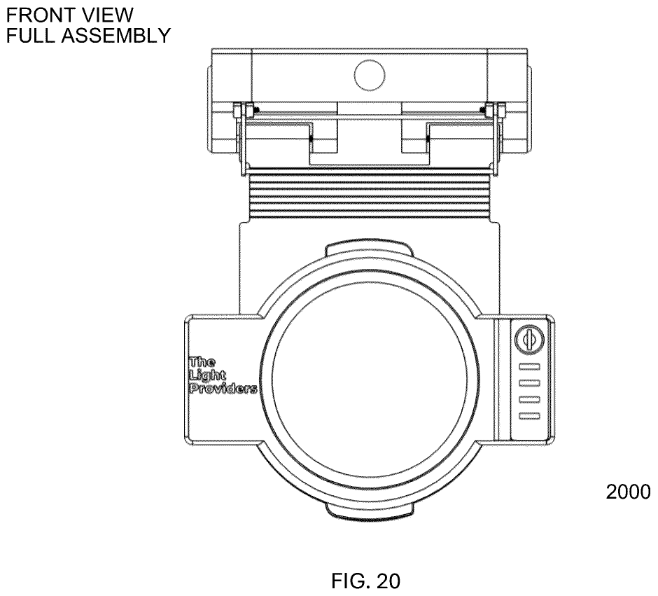

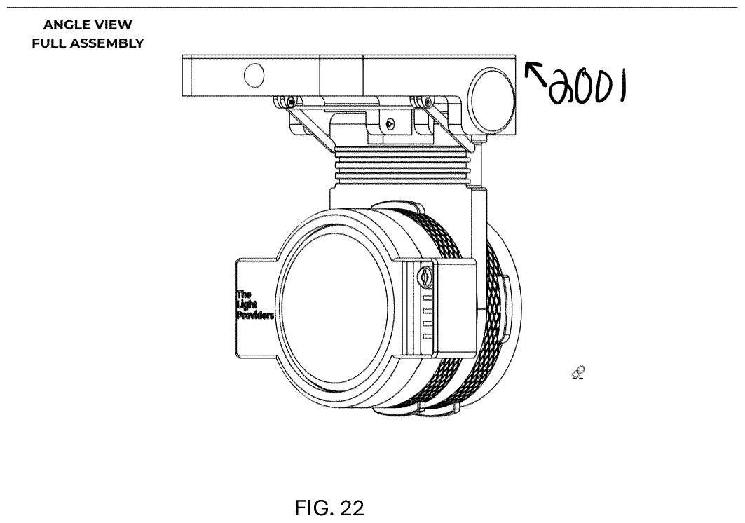

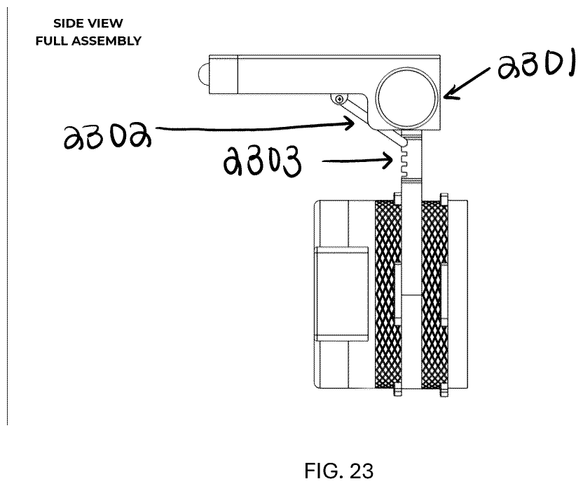

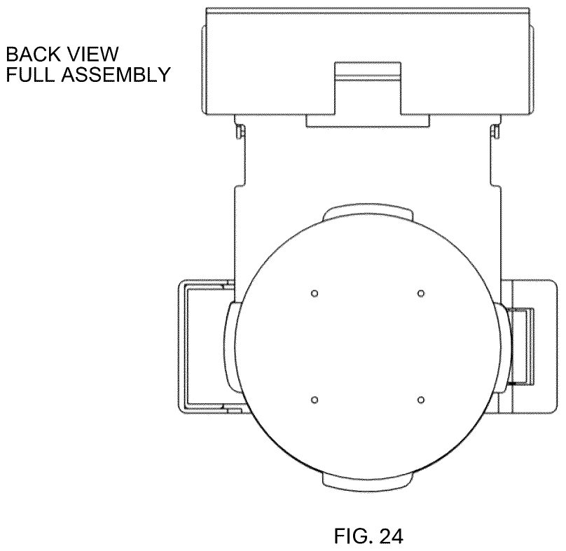

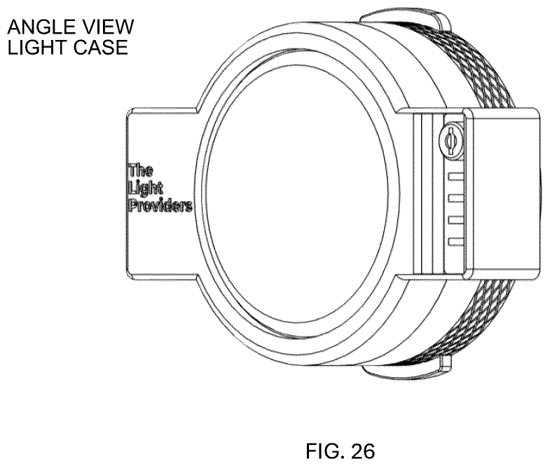

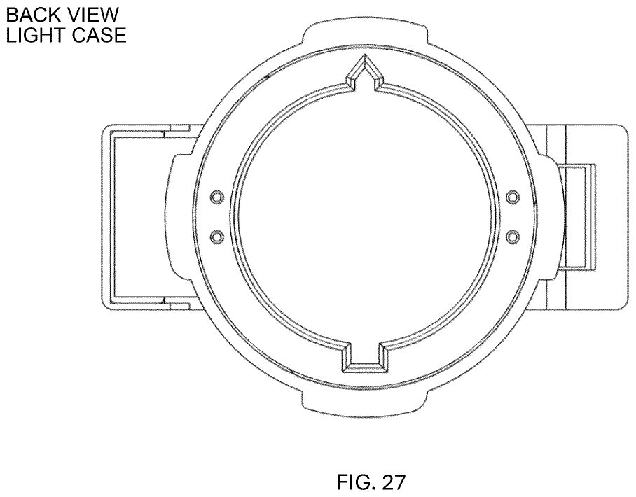

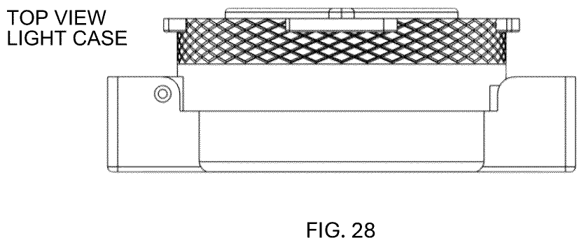

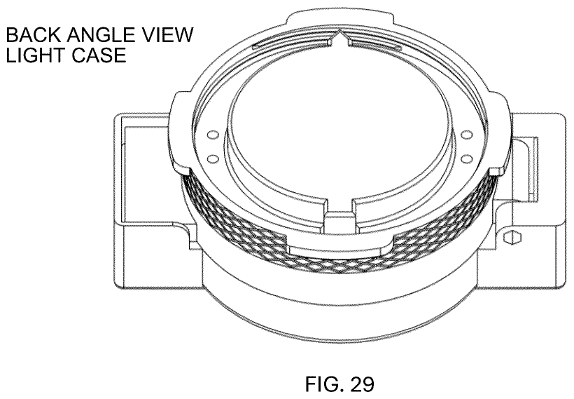

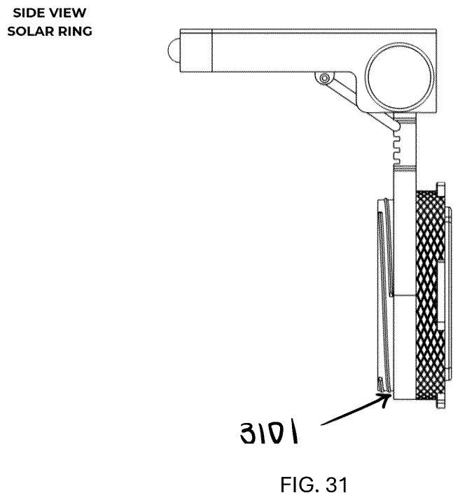

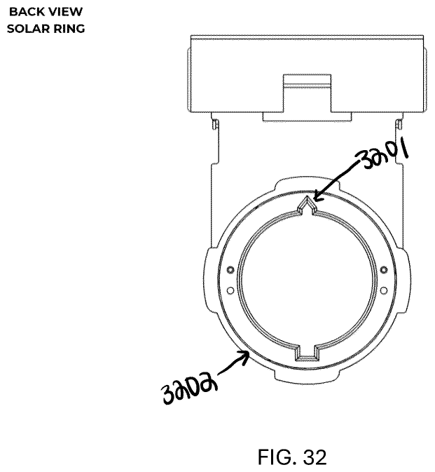

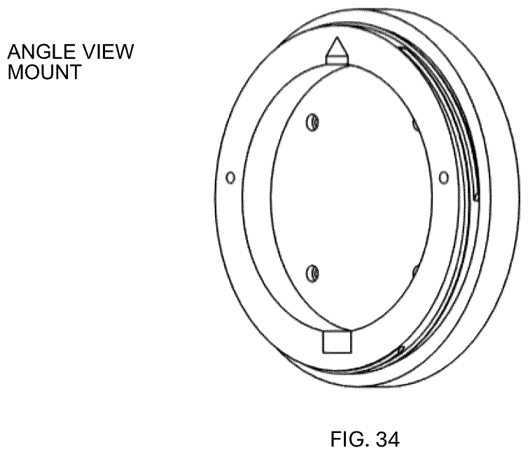

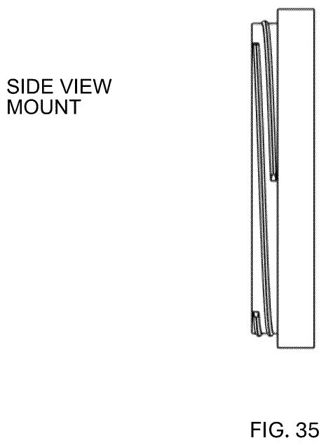

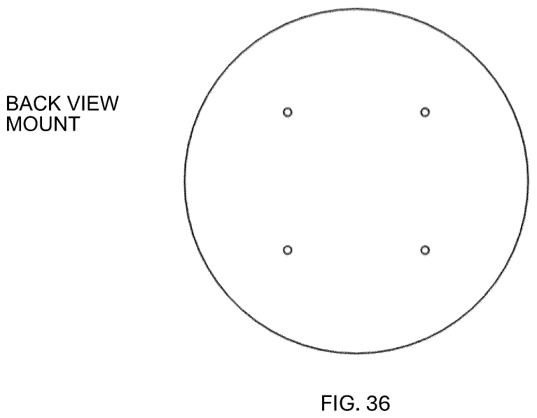

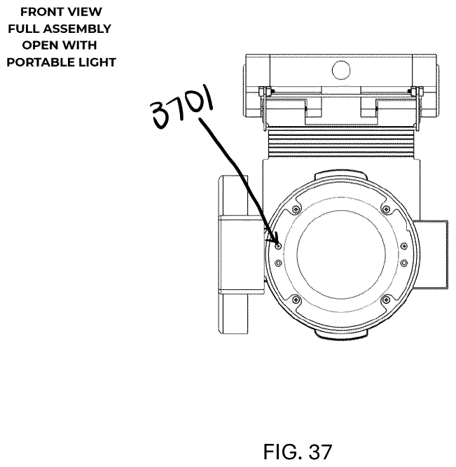

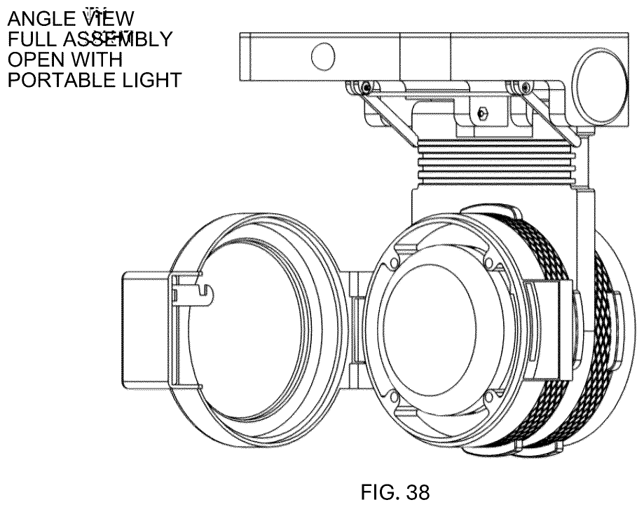

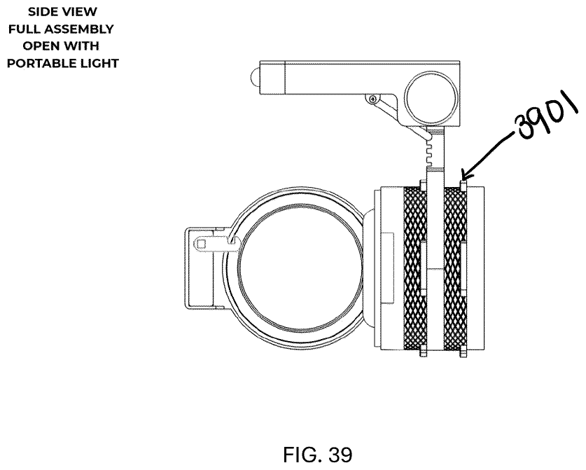

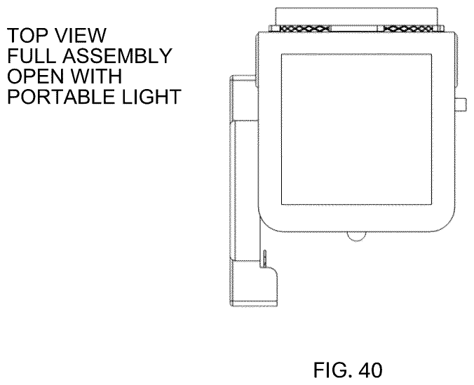

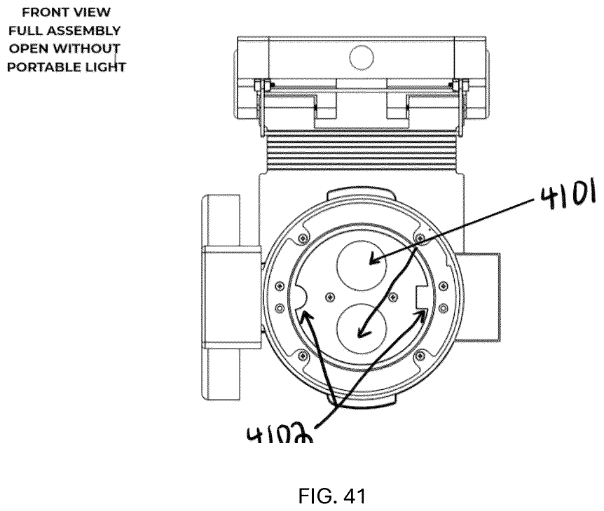

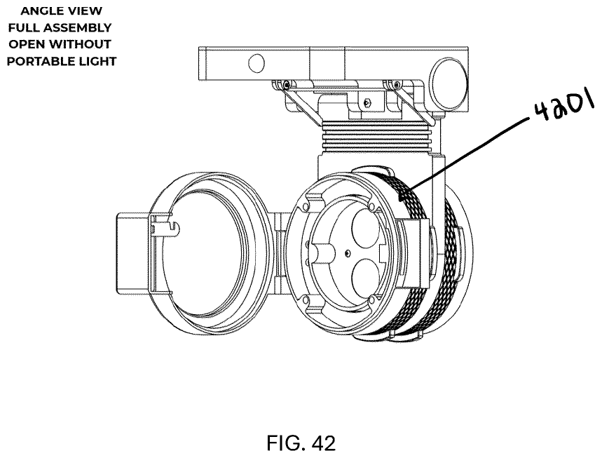

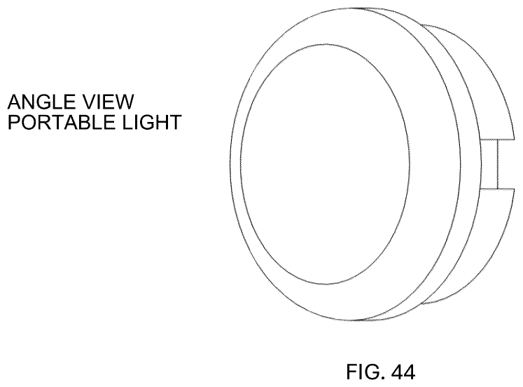

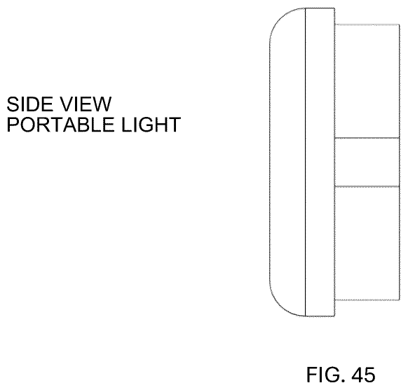

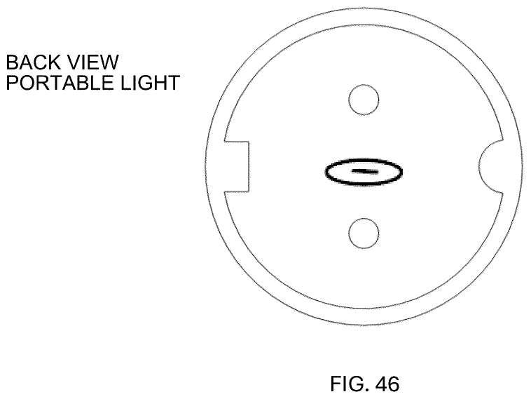

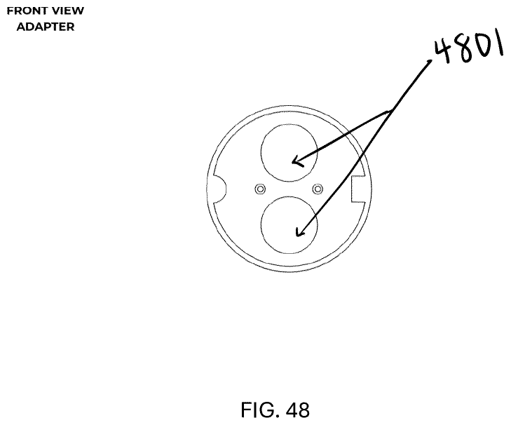

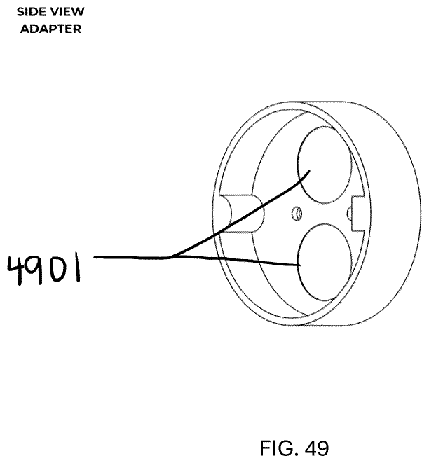

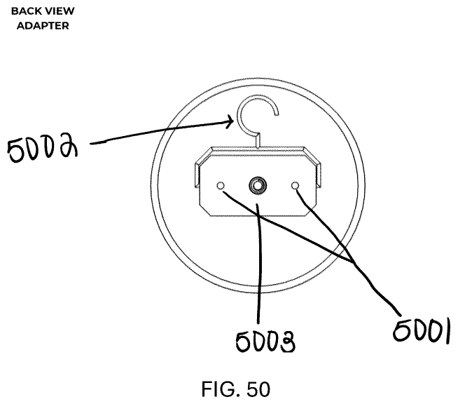

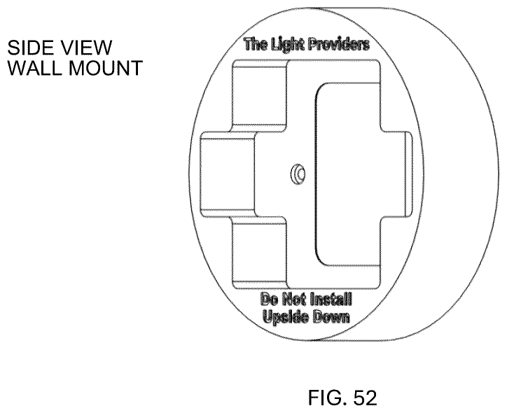

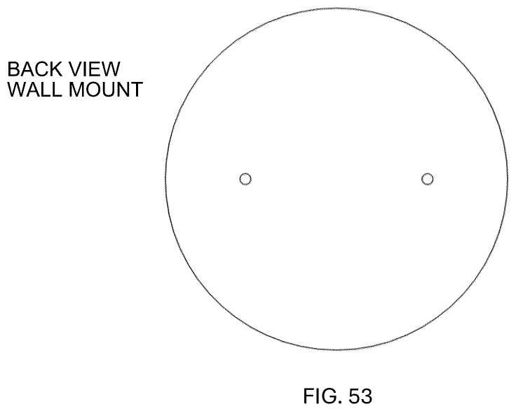

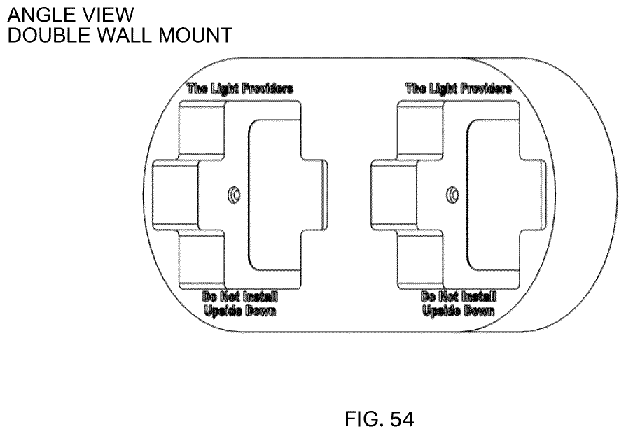

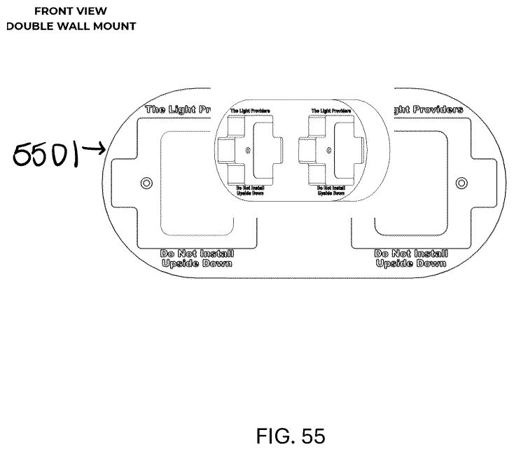

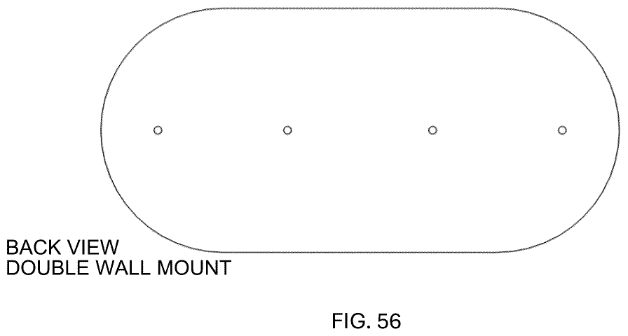

Referring to FIGS. 20-56, a wireless lighting system 2000 is provided. The wireless lighting system 2000. The wireless lighting system 2000 may be an example of the solar-powered lighting device 100, shown and described with reference to FIGS. 1-3 and 9-11. In some examples, the wireless lighting system 2000 may be a wireless LED lighting system. The wireless lighting system 2000 may comprise a light case 2005, a solar ring 2010, a mount 2015, a portable wireless light 2020, an adapter 2025, and a wall mount 2030. In some examples, the wireless lighting system 2000 may include a kickstand 2302 for a solar panel 2040 associated with the solar ring 2010. The kickstand 2302 may be positioned at an adjustable angle using notches and may enable the solar panel 2040 to be folded flat for transport. A profile of the wireless lighting system 2000 may orient the portable wireless light 2020 in the light case 2005 to ensure a power button and charging connections are in the same location each time the portable wireless light 2020 is inserted into the light case 2005. In some examples, the wireless lighting system 2000 may be secured with a locking mechanism 2045, such as a padlock, a built-in combination, key lock, or other type of locking mechanism. The wireless lighting system 2000 may include internal locking screws to secure the light case 2005 to the mount 2015, to secure the solar ring 2010 to the mount 2015, and to secure the light case 2005 to the mount 2015. The wireless lighting system 2000 may include a UMD alternative for the light case 2005 that allows the light case 20005 to swing from the side. In some examples, the wireless lighting system 2000 may be configured to attach to a wall using at least one hook 5002 and a screw attachment 5003 that is built-in to the adapter 2025. In this case, the wall mount may be configured to receive the wireless lighting system 2000 with the hook. In some examples, the wall mount 2030 may be configured to receive multiple wireless lighting systems 2000.

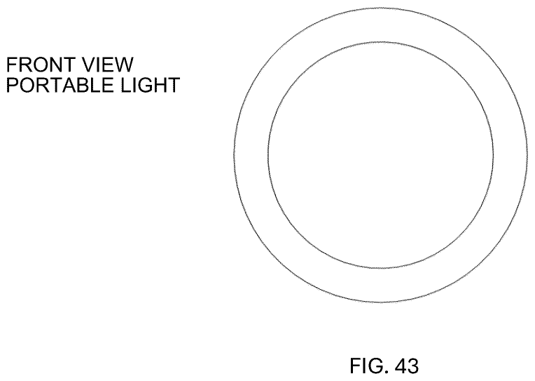

In some implementations, the portable wireless light 2020 (shown in FIGS. 43 to 47) may comprise a housing configured to receive one or more removable batteries (e.g., 18650 lithium-ion batteries) providing a capacity in the range of approximately 7,800 mAh to 10,500 mAh. The portable wireless light 2020 may be waterproof and rechargeable. In some examples, the portable wireless light 2020 (or housing thereof) may include a charging port (e.g., a USB-C charging port) for fast and reliable power replenishment. In some examples, the charging port may located be on a back or a side of the portable wireless light 2020. The portable wireless light 2020 (or housing thereof) may include one or more magnetic attachment means configured to secure the portable wireless light 2020 (or housing thereof) to a metallic surface for flexible of placement. The portable wireless light 2020 may provide dual functionality enabling the portable wireless light 2020 to function both as a lighting source and as a power bank for emergency charging of external devices. In some examples, the portable wireless light 2020 (or the wireless lighting system 2000) may include a plurality of battery level indicators (e.g., four indicators), such as disposed on a side or rear surface of the portable wireless light 2020, to provide an indication of a current battery level, remaining battery capacity, etc. In some examples, the portable wireless light 2020 may include a power control mechanism operable via a single button configured to toggle between multiple lighting modes in sequence, namely: low, medium, high, SOS, and OFF. In some examples, the housing of the portable wireless light 2020 may comprise an asymmetrical shape (e.g., square on one side, circular or curved on the other side), which may serve as a poka-yoke (e.g., mistake-proofing) mechanism, preventing users from inserting the portable wireless light 2020 incorrectly into the light case 2005 or adapter 2025. By providing an orientation control feature through the square and circular configuration 4102 of the asymmetrical housing profile consistent positioning of the power button and charging port within the light case 2005 may be ensured for intuitive operation, thereby simplifying user interaction and ensuring consistent electrical contact with charging interfaces. This may further facilitate secure mechanical engagement by restricting rotational movement and enabling compatibility with auxiliary locking mechanisms including, but not limited to, magnets, screws, pins or the like. In some implementations, the magnetic attachment feature may be eliminated in favor of mechanical engagement methods including locking tabs, internal screws, keyed slots, or the like to provide more secure and tamper-resistant mounting.

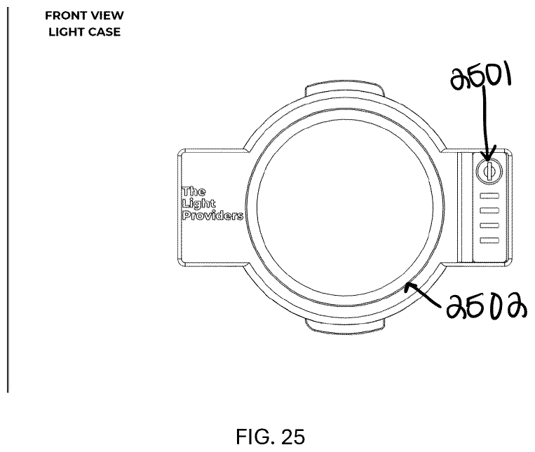

In some implementations, the portable wireless light 2020 may be disposed in the light case 2005 (shown in FIGS. 25 to 29). The light case 20005 may comprise a housing configured for both indoor and outdoor use. In some examples, the housing may be magnetic. In some examples, the light case 2005 may comprise a hinged front panel that opens to provide a docking structure (e.g., the housing) for removably receiving the portable wireless light 2020. In some examples, the light case 2005 may comprise a charging interface (e.g., a USB-C charging interface) integrated within the housing to enable charging. For instance, the interface may be configured to deliver an electrical charge to the portable wireless light 2020 and to interoperate with a solar power module, such as the solar ring 2010 for solar-powered recharging. The light case 2005 may further include an LED ring 2502 disposed within the housing. The LED ring 2502 may be configured to emit an increased illumination when the portable wireless light 2020 is docked. The LED ring 2502 may further be configured to operate independently when electrically connected to the solar ring 2010. The light case 2005 may further comprise a security locking mechanism incorporated into the housing. The security locking mechanism 2501 may comprise a combination lock, a key-access lock, or other locking mechanism to prevent unauthorized removal of the portable wireless light 2020. The light case 2005 may comprise a wall-mountable design including a standard mount, such as mount 2015, with a male threaded profile 3004 and a locking screw insert 3003, and where the light case 2005 includes a complementary female thread profile 3202 for secure attachment. The female thread profile 3202 may match a male thread profile disposed on the mount 2015. The light case 2005 may further include an alignment key 3201 disposed on a surface of the light case 2005, such as a rear surface. The alignment key may be configured to engage (e.g., inserted) with a corresponding slot on the mount 2015 or the solar ring 2010 to ensure proper directional orientation. A locking ring may be configured to be screwed into position once the light case 2005 is mounted, thereby enabling the light case 2005 to be fixed in place by one or more fasteners (e.g., at least two fasteners). In this way, once locked, the light case 2005 may not be removed from the mount 2015 without unlocking the locking mechanism. In some examples, an external battery indicator may be positioned on the housing of the light case 2005. The external battery indicator may be configured to display a current battery level of the portable wireless light 2020.

In some implementations, a mechanical latching system may be utilized to secure the portable wireless light 2020 to the light case 2005. The mechanical latching system may be comprised of keyed slots and internal locking screws, enabling a secure and precise engagement between the portable wireless light 2020 to the light case 2005. The housing of the light case 2005 may further include an internal alignment guide that ensures the portable wireless light 2020 is oriented identically with each insertion, guaranteeing the power button and charging interface remain consistently positioned for operational convenience. The light case 2005 may be further configured to mechanically attach to a standard mount, such as the mount 2015, via screw-lock fasteners and twist-lock coupling, enabling stable integration with both wall mounts, such as the wall mount 2030, and the solar ring 2010.

In some examples, the light case 2005 may be configured with an alternate access mechanism. For instance, the light case 2005 may be configured with a swing-to-side access mechanism (e.g., a UMD-style swing). In this case, the light case 2005 may comprise a pivotable mount system, where the light case 2005 may be attached via a hinged or rotating arm configured to swing laterally from a vertical mount point. The swinging mechanism may enable quick access to the portable wireless light 2020 for charging or removal without requiring complete detachment from a mounted position. A locking latch may be configured to secure the light case 2005 in the closed position during use, and may comprise a limit-stop feature restricting overextension during opening, thereby enhancing durability and alignment precision.

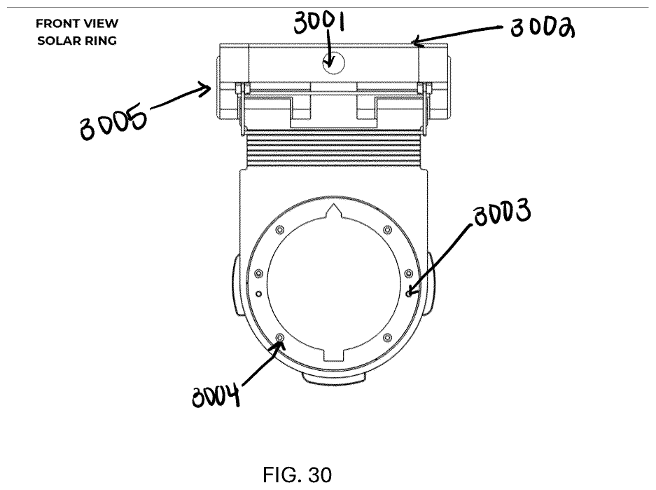

In some implementations, the wireless lighting system 2000 may include a solar-powered accessory module (shown in FIGS. 30-32). The solar-powered accessory module may comprise the solar ring 2010 and the solar panel 2040. The solar-powered accessory module may comprise a housing that may be waterproof and weather-resistant, and may be built to withstand outdoor conditions while maintaining reliable performance.

The solar ring 2010 may be a ring-shaped comprising photovoltaic cells adapted to convert solar energy into electrical energy for recharging an internal or connected battery. The solar ring 2010 may be configured to attach to a back surface of the light case 2005. The solar ring 2010 may include a dual-interface system comprising both electrical and mechanical attachment features, such as a keyed alignment interface for proper directional orientation, and a screw-lock or twist-to-secure mechanism enabling the solar ring 2010 to attach directly to the rear surface of the light case 2005 or to a standard mount, such as the mount 2015. This configuration may permit the solar ring 2010 to serve as a bridging module, facilitating both physical and electrical connectivity between the mount 2015 and the light case 2005. When attached to the light case 2005, the solar ring 2010 may convert the light case 2005 to an outdoor solar light that may be used to recharge a battery. In some examples, the solar ring 2010 may turn on when motion is sensed and remain off when no motion is sensed for a period of time, thus conserving the battery. The solar ring 2010 may be connectable (e.g., attachable) to the light case 2005 via a charging mechanism (e.g., a USB-C charging mechanism). For instance, an attachment interface on a front side of a housing of the solar ring 2010 may be configured to connect to a rear surface of the light case 2005 via a USB-C port or alternative charging mechanism, thereby enabling electrical communication between the solar ring 2010 and the portable wireless light 2020. The solar ring 2010 may further comprise a motion sensor 3002, side lights 2391 or 3005 (e.g., LED lights), or a combination thereof. The motion sensor may detect movement within a predefined range and may activate the side lights in response to detected motion for security and energy efficiency.

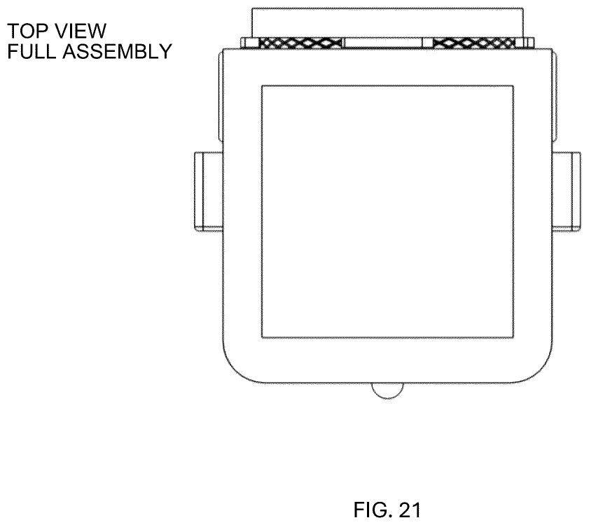

The solar panel 2040 (shown in FIG. 21) (or solar panel 3002) may disposed on a top surface of the housing of the solar-powered accessory module, The solar panel 2040 may be may be configured for outdoor mounting. The solar panel 2040 may harnesses solar energy to recharge the portable wireless light 2020. The solar panel may be configured to convert solar energy into electrical power for recharging an internal battery and/or the portable wireless light 2020. The solar panel 2040 may comprise a folding mechanism that may enable the solar panel 2040 to collapse flat against the housing for compact storage and transport. The folding configuration may further protect the solar panel 2040 during shipping. The kick stand 2302 may be integrated into the housing of the solar-powered accessory module and may be configured to support the solar panel 2040 at an adjustable angle. The kick stand 2302 may include preset notches 2303 or detents to accommodate region-specific solar alignment angles for optimal energy efficiency.

In some examples, the solar-powered accessory module may further include internal battery storage for housing an internal rechargeable battery. The battery may be configured to store power collected during the day for nighttime operation and recharging of the portable wireless light 2020 when sunlight is not available.

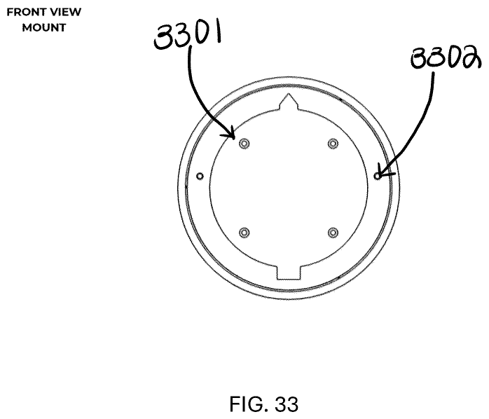

In some implementations, the mount 2015 (shown in FIGS. 33 to 36) may be a standard mount. The mount 2015 may comprise a threaded mounting bracket for easy installation. The threaded mounting bracket may be configured for attachment, via attachment holes 3301, to a vertical wall surface using screws and wall anchors to enable secure installation on a wall surface, such as drywall, wood, concrete, and similar materials. A threaded male mounting post may be integrated into the bracket, dimensioned to mate with a corresponding female threaded receptacle on the portable wireless light 2020 or the light case 2005, allowing for quick and secure screw-on installation. The mount may additionally comprise a locking screw insert 3301.

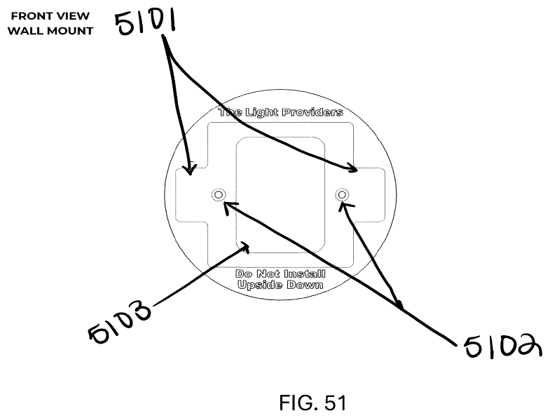

In some implementations, the wall mount 2030 (shown in FIGS. 51 to 56) may be utilized to support one or more wireless lighting systems 2000. The wall mount 2030 may comprise a bracket configured for attachment to a vertical wall surface via wall attachment holes 5102 using a plurality of screws to ensure stable and secure installation on various surface materials including drywall, wood, concrete, etc. The wall mount 2030 may include a metal plate 5103 and a hook-compatible opening 5101 integrated into the bracket. The opening may be dimensioned and shaped to receive and securely retain the hook 5002 of a wireless lighting system 2000, such that the wireless lighting system 2000 may be slid and locked into place and held without additional fasteners, with the geometry of the opening preventing unintentional movement or dislodgment. The wall mount 2030 may be further configured to support one or more wireless lighting systems 2000 simultaneously, with mounting orientations permitting side-by-side or vertically stacked arrangements to increase brightness output in larger or darker spaces. The wall mount 2030 may be specifically optimized for wall-mounted installation, with the open design supporting vertical hanging orientation. In some implementation, alternative attachment mechanisms may be utilized, such as a magnetic interface between the wall mount 2030 and the wireless lighting system 2000, or a snap-fit coupling system enabling quick attachment and removal without the use of threads or fasteners.

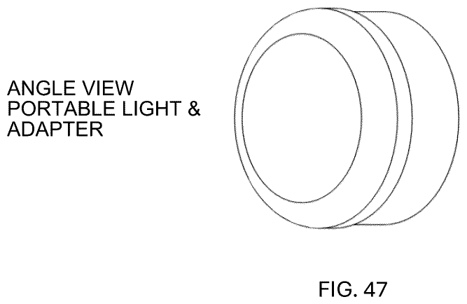

In some implementations, the adapter 2035 (shown in FIGS. 47 to 50) may enhance a versatility and mounting options of the wireless lighting system 2000, allowing the wireless lighting system 2000 to be used in various environments and applications. The adapter 2035 may include a magnetic attachment surface configured to securely hold a portable wireless light 2020 while permitting easy attachment and detachment. The adapter 2035 may enable various mounting options. For instance, a first mounting option may include an integrated threaded screw attachment 5003 (e.g., ¼ inch) located on a rear surface of the adapter 2035, adapted for engagement with tripods, camera mounts, and universal mounting systems. A second mounting option may include a built-in hook 5002 mechanism configured to allow the adapter 2035 to be suspended from elongated structures, such as poles or ropes. A third mounting option may include a wall-mountable structure including one or more apertures, e.g., wall attachment holes 5001, to enable permanent or semi-permanent attachment to a vertical surface via screws. The adapter 2035 may additional include one or more metal plates 4101, 4801, and 4901.

The wireless lighting system 2000 may additionally include locking screw holes 3701 and a locking ring 3901.

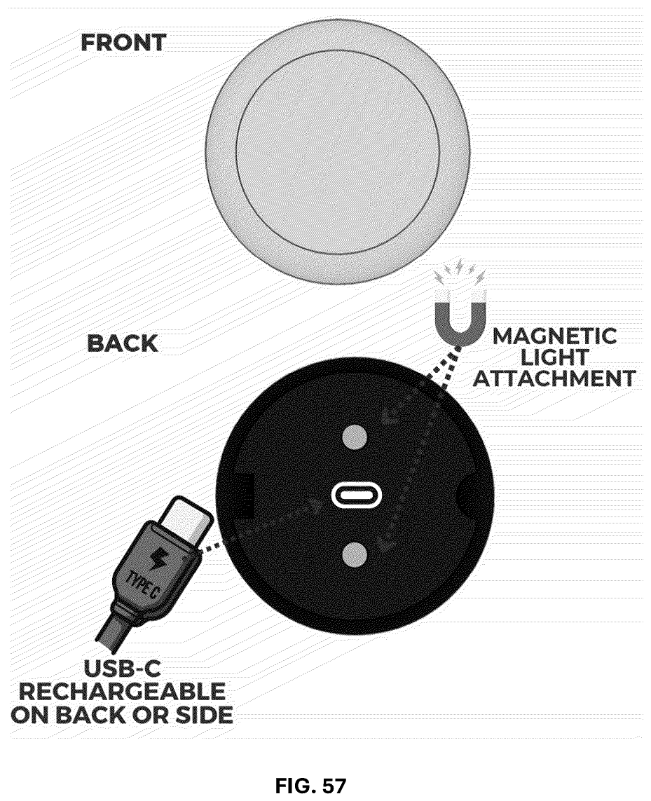

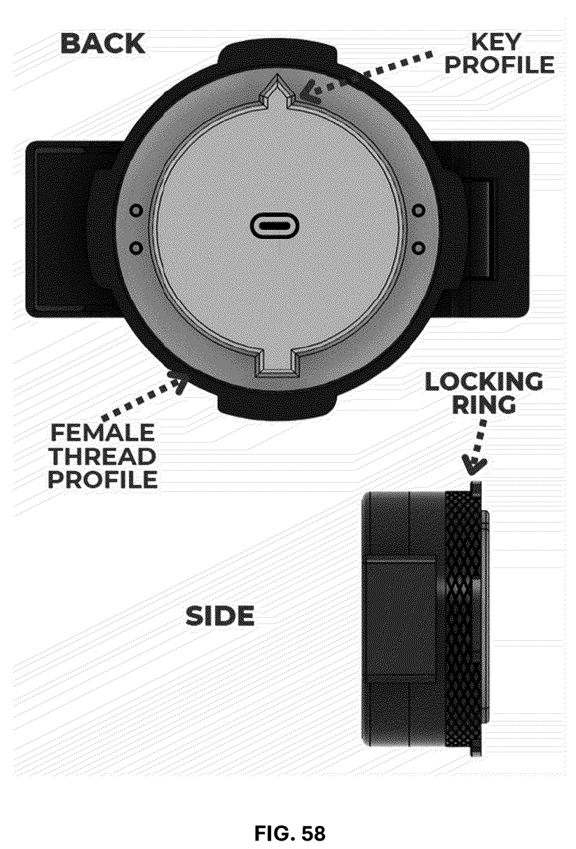

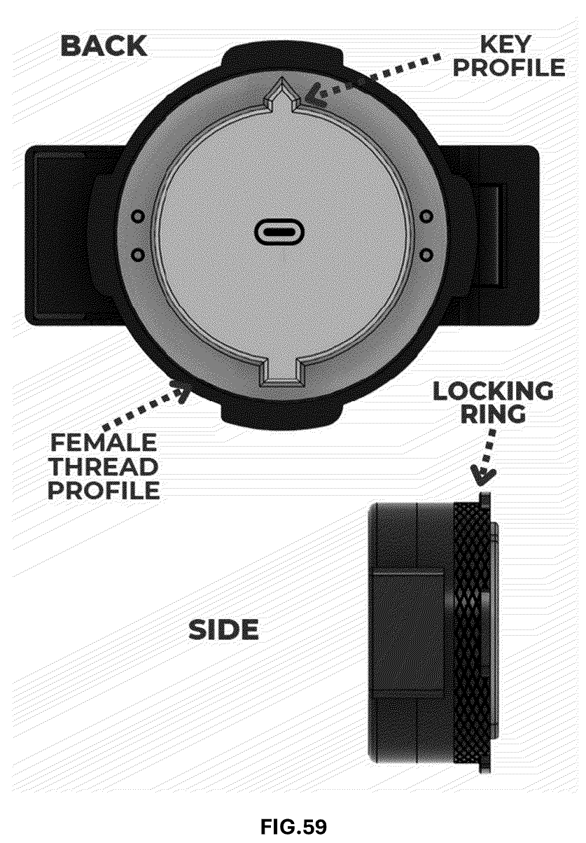

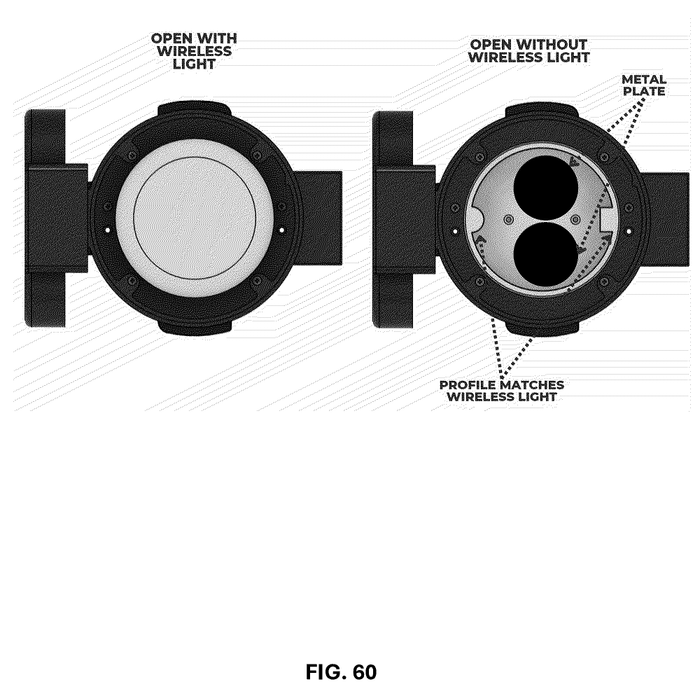

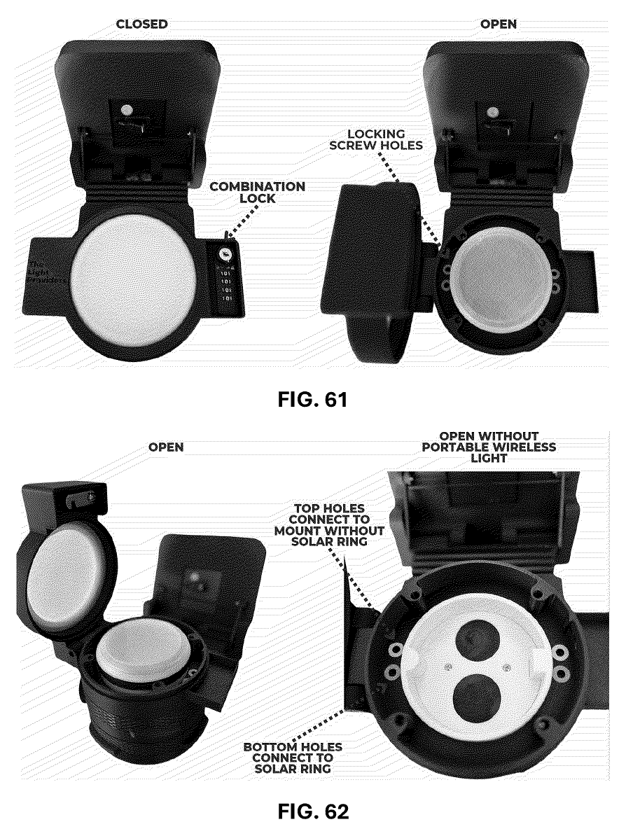

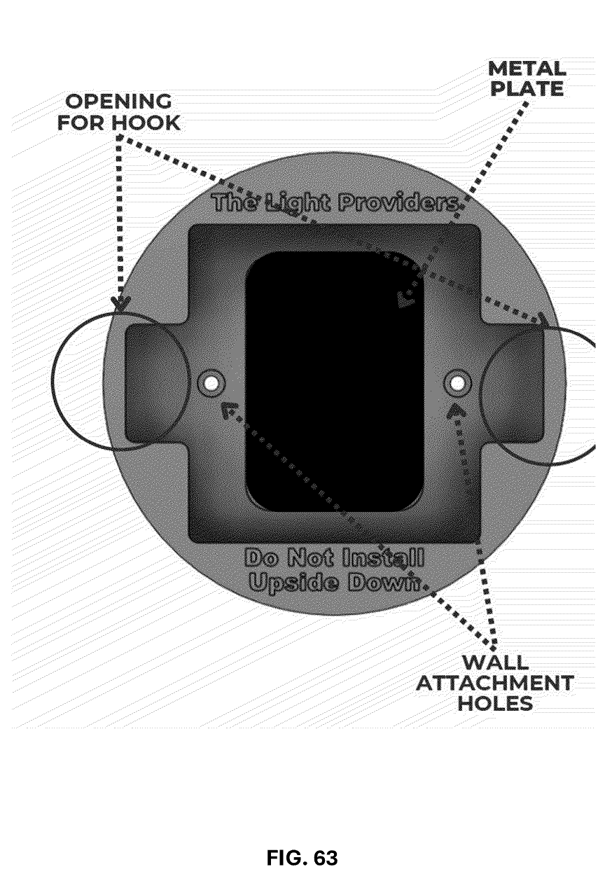

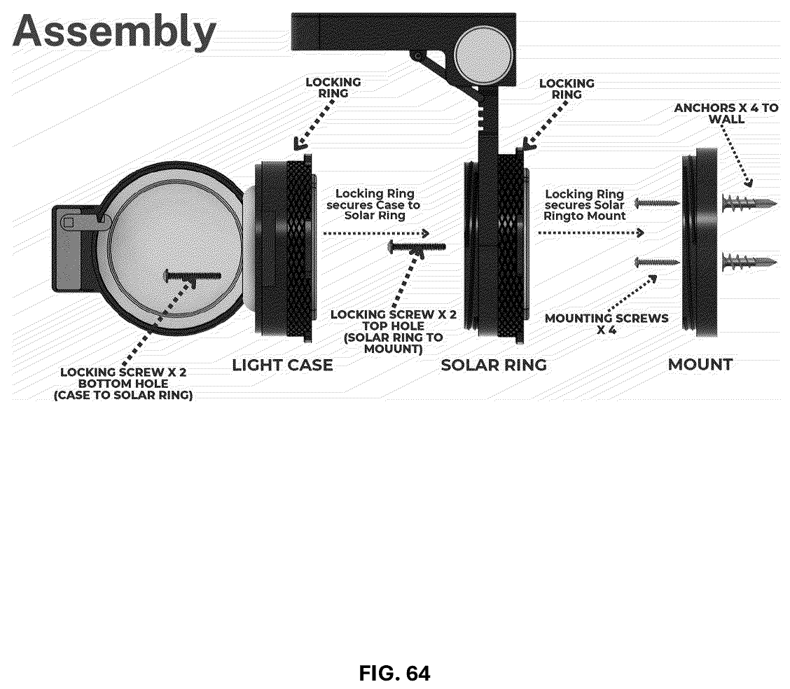

Various views, components, and a method of assembly of the wireless light systems described with reference to FIGS. 1 to 56 are illustrated in FIGS. 57-64, according to certain aspects of the present disclosure.

Terms of degree such as “generally,” “substantially,” “about,” and “approximately” as used herein mean a reasonable amount of deviation of the modified term such that the end result is not significantly changed. For example, these terms can be construed as including a deviation of at least +−0.5% of the modified term if this deviation would not negate the meaning of the word it modifies. It should be noted the terms “including” and “comprising” should be interpreted as meaning “including, but not limited to.”

In this specification, “a” and “an” and similar phrases are to be interpreted as “at least one” and “one or more.” References to “the,” “said,” and similar phrases should be interpreted as “the at least one,” “said at least one,” etc. References to “an” embodiment in this disclosure are not necessarily to the same embodiment.

It is intended that only claims that include the express language “means for” or “step for” be interpreted under 35 U.S.C. § 112(f). Claims that do not expressly include the phrase “means for” or “step for” are not to be interpreted under 35 U.S.C. § 112(f).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A solar-powered lighting device comprising:
a solar ring featuring a solar panel, side lighting, and a motion sensor allowing for a light source to collect solar energy;
a wireless light source and a battery that uses the collected solar energy and produces electrical energy;
a case that attaches the wireless light source and the battery to various mounts; and
a mounting system that includes a lock and key mechanism, a fastening mechanism, and threading to allow for secure attachment between at least one mount and the case.

2. The solar-powered lighting device of claim 1, wherein the case further comprises a padlock locking feature that protects the solar-powered lighting device from theft or damage.

3. The solar-powered lighting device of claim 1, wherein the solar ring further comprises a solar panel that converts solar energy into electrical energy.

4. The solar-powered lighting device of claim 1, wherein the solar ring further comprises a side lighting that provides additional lighting capabilities separate from a central light.

5. The solar-powered lighting device of claim 1, wherein the solar ring further comprises a motion sensor configured to activate a central solar-powered light when motion is detected and to deactivate the central solar-powered light when no motion is detected for a predetermined period of time.

6. The solar-powered lighting device of claim 1, wherein the case comprises one or more magnets and shaped molding to secure the wireless light source and the battery.

7. The solar-powered lighting device of claim 1, wherein the wireless light source and battery further comprises a shape to fit securely in a molding of the case.

8. The solar-powered lighting device of claim 1, wherein the wireless light source and the battery further comprises a charging port to provide energy to an exterior device.

9. The solar-powered lighting device of claim 1, wherein the mounting system further comprises holes to allow the mount to be secured onto a surface.

10. The solar-powered lighting device of claim 1, wherein the lock and key mechanism is configured to secure the at least one mount to the case and the solar ring utilizing corresponding lock and key mechanisms.

11. The solar-powered lighting device of claim 1, wherein the mounting system further comprises a tightening system comprising one or more ridges and a protruding grip to grip and twist the system to tighten a connection between the mount and a component.

12. The solar-powered lighting device of claim 1, wherein the case comprises a lock and key mechanism and threading for stable attachment to the one or more mounts.

13. The solar-powered lighting device of claim 1, wherein the one or more mounts includes a standard mount, the solar ring, a floating mount, or a double-sided mount.

14. The solar-powered lighting device of claim 1, wherein the case further comprises an opening and closing mechanism including a grip portion to open the case and access the wireless light source and the battery.

15. A method for creating solar light, the method comprising:
mounting a mount to a secure location;
attaching a solar ring to the mount; and
attaching a case comprising a wireless lighting device and battery to the solar ring.
